(19) United States
(12) Patent Application Publication
(10) Pub. No.: US 2009/0320814 A1
(43) Pub. Date: Dec. 31, 2009

(54) System and method for controlling an internal combustion engine using flame speed measurement

(75) Inventors: Scott Byron Fiveland, Metamora, IL (US); Martin Leo Willi, Dunlap, IL (US); David Todd Montgomery, Edelstein, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/216,058

(22) Filed: Jun. 27, 2008

(51) Int. Cl. F02D 41/00

(52) U.S. Cl. 123/704

(57) ABSTRACT

A system is disclosed for controlling a combustion engine. The system includes a measurement apparatus disposed external to a combustion chamber of the engine. A device is configured to selectively direct an amount of air and fuel to the measurement apparatus. An ignition source is configured to ignite the air and fuel to produce a flame propagating within the measurement apparatus. A sensor is configured to measure at least one parameter associated with the flame propagating within the measurement apparatus. A controller is configured to determine a flame speed within the measurement apparatus based on the at least one measured parameter, and to control an operating flame speed in the engine by managing an air/fuel ratio of the engine based on the determined flame speed.

### TECHNICAL FIELD

The present disclosure relates generally to a flame speed measurement and, more particularly, to a system and method for controlling an internal combustion engine using flame speed measurement.

### BACKGROUND

In a combustion engine, such as a natural gas engine that uses a premixed charge (i.e., air and fuel mixture) and flame-propagation-driven combustion, conditions of the fuel and the surrounding environment may vary at different times, at different locations, or with different suppliers of the fuel. Such conditions of the fuel may include compositions of the fuel. For example, natural gas is typically a mixture of different gases, which may include methane, ethane, propane, butane, pentane, carbon dioxide, nitrogen, helium, etc. The percentage of each component gas may vary since the natural gas may be drawn from different gas fields. In addition, as the fuel is transported from one location to another, for example, via fuel pipelines, the conditions (e.g., component percentage, density, etc.) of the fuel may also change. The changing conditions in the fuel, as well as the changing conditions in the air, such as humidity level, temperature, etc., may affect the combustion of the air/fuel mixture. For example, the variations of the conditions of the air/fuel mixture may cause variations in combustion (which may be represented by variations in flame speed of the burning air/fuel mixture), thereby causing inconsistent combustion and thus inconsistent engine performance. As a result, the engine may experience undesirable phenomena, such as detonation, lower combustion efficiency, and wandering NOₓ emissions, etc. Natural gas engines, for example, often suffer from inconsistent engine performance because of the above mentioned fuel and environmental condition variations.

Consistent engine combustion is often desired for various reasons, for example, for efficient engine performance, for emissions control, etc. Consistent engine operation is often realized by maintaining a consistent flame speed of the air/fuel mixture, which may be maintained by adjusting the air/fuel ratio of the air and fuel mixture supplied to the engine and combusted therein. Some currently known technologies adjust the air/fuel ratio based on the oxygen content in exhaust gases measured by an oxygen sensor disposed in the exhaust system. However, the accuracy of such technologies is often not satisfactory, partly because these technologies do not account for the direct impact of the fuel and environmental condition changes on flame speed and the combustion rate of the air/fuel mixture. Because the measured parameter is the oxygen content in the exhaust gases produced after combustion, the correlation between the oxygen content and the flame speed (or the air/fuel ratio) may not be accurate enough to reflect the actual engine operating conditions (e.g., actual flame speed), and therefore may not be able to account for the variations in the fuel/air conditions. Other systems may use measured electrical power in lieu of measured oxygen content as a feedback for controlling the air/fuel ratio. However, such systems have limitations similar to those using oxygen sensors, as discussed above.

A method and apparatus for maintaining the air/fuel ratio of a combustion engine is described in U.S. Pat. No. 4,686,951 (the '951 patent) issued to Snyder on Apr. 18, 1987. A small sample portion of an air/fuel mixture is withdrawn into a burner and burnt as a flame or oxidized by a catalyst in the burner, thereby producing exhaust gases. The oxygen content of the produced exhaust gases is measured by an oxygen sensor. The measured oxygen content is then used by a servo to control the air/fuel ratio in order to maintain the stoichiometry of the air/fuel mixture.

While the method described in the '951 patent may allow for adjustment of the air/fuel ratio based on the measured oxygen content of the burnt sampled air/fuel mixture, the method may be problematic, particularly when a certain flame speed is desired in the engine. First, the method may not account for the variations in the fuel and air conditions since only the oxygen content of the exhaust gases is measured. Second, the correlation between the measured oxygen content in the exhaust gases and the air/fuel ratio may not be accurate enough to reflect the actual engine operation conditions, particularly the actual flame speed in the engine. Therefore, the disclosed method may not be sufficiently accurate for maintaining consistent engine operations.

The system and method of the present disclosure are directed toward improvements in the existing technology.

### SUMMARY

In one aspect, the present disclosure is directed to a system for controlling a combustion engine. A measurement apparatus is disposed external to a combustion chamber of the engine. A device is configured to selectively direct an amount of air and fuel to the measurement apparatus. An ignition source is configured to ignite the air and fuel to produce a flame propagating within the measurement apparatus. A sensor is configured to measure at least one parameter associated with the flame propagating within the measurement apparatus. A controller is configured to determine a flame speed within the measurement apparatus based on the at least one measured parameter, and to control an operating flame speed in the engine by managing an air/fuel ratio of the engine based on the determined flame speed.

In another aspect, the present disclosure is directed to a method of controlling a combustion engine. The method includes directing a selected amount of air and fuel to a measurement apparatus disposed external to a combustion chamber of the engine. The method also includes igniting the selected air and fuel to produce a flame propagating within the measurement apparatus. The method also includes measuring at least one parameter associated with the flame propagating within the measurement apparatus. The method also includes determining a flame speed of the flame within the measurement apparatus based on the at least one measured parameter. The method further includes controlling an operating flame speed in the engine by managing an air/fuel ratio based on the determined flame speed.

### BRIEF DESCRIPTION OF THE DRAWINGS

FIG. 1 is a schematic illustration of an exemplary engine system in which the disclosed system for controlling a combustion engine may be employed; and

FIG. 2 illustrates an exemplary process of operating the system for controlling a combustion engine.

### DETAILED DESCRIPTION

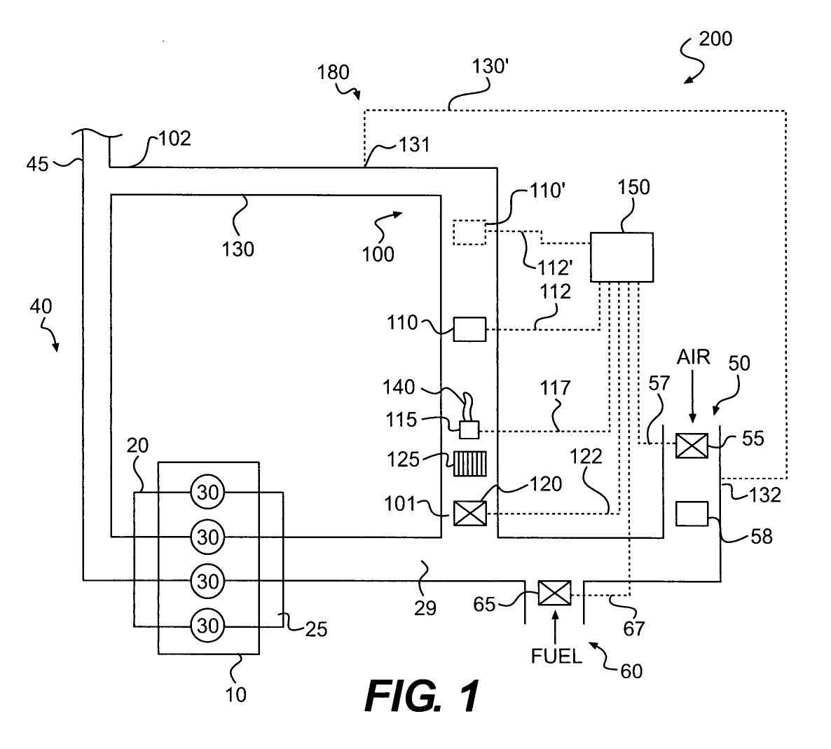

FIG. 1 schematically illustrates an exemplary engine system 200. The engine system 200 may be employed in any machine, for example, a wheel loader, a track-type tractor, an excavator, an on- or off-highway vehicle, a power generator, etc. The engine system 200 may include a combustion engine 10, which may be a gasoline engine, a diesel engine, a natural gas engine, a gas turbine engine, or any other pre-mixed charge combustion engine that combusts an air and fuel mixture to produce power, and which produces exhaust gases after combustion.

Engine 10 may include at least one combustion chamber 30 for combusting the air and fuel mixture. Engine 10 may include one or more intake valves (not shown) and one or more exhaust valves (not shown). Engine 10 may also be associated with an intake manifold 25, which directs the air and fuel mixture to the combustion chamber(s) 30. Engine 10 may also be associated with an exhaust manifold 20, which may receive exhaust gases from combustion chamber(s) 30.

The engine system 200 may include an air intake system 50, an exhaust system 40, and a fuel supply system 60. The air intake system 50 may include a valve 55, which may be a flow control valve, and various other components known in the art. The valve 55 may be moved between opened and closed positions to variably control air flow into the air intake system 50, and further into engine 10. The fuel supply system 60 may supply fuel to the combustion chamber(s) 30 for combustion. The fuel may be a natural gas, gasoline, diesel, hydrogen, etc. The fuel may be in a gaseous state, such as hydrogen, natural gas, and may also be in a vaporized liquid state with finely distributed small droplets, for example, vaporized diesel, etc. The fuel supply system 60 may includes a valve 65, which also may be a flow control valve, and various other components known in the art. The valve 65 may be moved between opened and closed positions to variably control fuel flow into the fuel supply system 60, and further into engine 10. The air intake system 50 and the fuel supply system 60 may both be connected with a passage 29, where air supplied from the air intake system 50 and fuel supplied from the fuel supply system 60 may be mixed together according to a predetermined ratio (air/fuel ratio) to form an air and fuel mixture. The passage 29 may be configured to supply air and fuel to engine 10 through the intake manifold 25, which may be connected with the passage 29. The air/fuel ratio of the air and fuel supplied to engine 10 may be adjusted by valve 55 that controls the amount of air intake, and by valve 65 that controls the amount of fuel intake.

The engine system 200 may include a system 180 for controlling engine 10. The system 180 may include a measurement apparatus 100 disposed external to the combustion chamber(s) 30 of engine 10. The measurement apparatus 100 may have a tube structure (e.g., a pipe) including a first end 101. The first end 101 may be connected with a suitable portion of the passage 29, for example, a portion of the passage 29 adjacent the intake manifold 25, where air and fuel may be mixed. Alternatively, although not shown in FIG. 1, it is contemplated that an amount of air and an amount of fuel may be independently directed into the apparatus 100 through the first end 101 according to the same air/fuel ratio as that of the air and fuel supplied to the engine 10. The air and fuel independently directed into the apparatus 100 may then be mixed in the apparatus 100. It is contemplated that the first end 101 of the apparatus 100 may be connected with the air intake system 50 and the fuel supply system 60 through two independent passages (not shown) for sampling the air and the fuel. Within the measurement apparatus 100, sampled air and fuel may be ignited to produce a flame and exhaust.

In some embodiments, the measurement apparatus 100 may include a first exhaust conduit 130 connected with a portion 45 of the exhaust system 40, for example, an exhaust pipe, at a second end 102 of the measurement apparatus 100. The exhaust from measurement apparatus 100 may be directed into the exhaust system 40 through the first exhaust conduit 130. In this configuration, the heat of the exhaust produced from burning air and fuel within the measurement apparatus 100 may be utilized by the exhaust system 40 to warm components of the exhaust system 40. That is, some components, for example a catalyst or a particulate regenerator, may only function properly when a temperature of the exhaust passing through those components is within a predetermined activation range. For this reason, the heat produced by measurement apparatus 100 may be used to control temperatures of these components.

Alternatively, in some embodiments, the measurement apparatus 100 may include a second exhaust conduit 130′ instead of or in addition to the first exhaust conduit 130, through which the exhaust may be directed back to the air intake system 50. Second exhaust conduit 130′ may be disposed between a portion 131 of the measurement apparatus 100, and a portion 132 of the air intake system 50. The portion 132 of the air intake system 50 may be located upstream of a compressor 58 of the air intake system 50. The exhaust directed back to the air intake system 50 through the second exhaust conduit 130′ may be further directed to the combustion chamber(s) 30 for combustion.

The system 180 may also include a device 120 configured to selectively direct an amount of air and fuel to the measurement apparatus 100. For example, the device 120 may direct a selected amount of air and fuel to flow into the measurement apparatus 100 from the passage 29 through the first end 101. The device 120 may include a valve, e.g., a solenoid controlled valve, which may be opened to allow an amount of air and fuel to flow into the measurement apparatus 100, and closed to block the air and fuel from flowing into the measurement apparatus 100. The amount of air and fuel directed into the measurement apparatus 100 may be variably adjusted by the device 120. The device 120 may, for example, be disposed within the measurement apparatus 100, and may be disposed adjacent the junction of the passage 29 with measurement apparatus 100, etc. The system 180 may include a controller 150, which may be part of an existing engine control module (ECM) used to control engine 10, or which may be a stand-alone control module. The device 120 may be linked with the controller 150 via a communication line 122. The controller 150 may communicate with the device 120 by sending signals to and receiving signals from the device 120 via the communication line 122.

The system 180 may also include an ignition source 115 configured to ignite the selected air and fuel directed to the measurement apparatus 100 by the device 120 to produce a flame 140 propagating within the measurement apparatus 100. The ignition source 115 may be a spark plug, or any other suitable ignition device. The ignition source 115 may be associated with the controller 150 via a communication line 117, and may communicate with the controller 150 via the communication line 117. The flame 140 may be a substantially laminar flame, which is relatively more measurable and controllable compared to a flame produced inside the engine where the flame may be disturbed by combustion turbulence and engine geometry.

The system 180 may also include a first sensor 110 configured to measure at least one parameter associated with the flame 140 propagating within the measurement apparatus 100. The first sensor 110 may be disposed at least partially within the measurement apparatus 100, and may be located at a predetermined distance from the ignition source 115. The flame 140 may propagate from the ignition source 115 to the first sensor 110, which may be any suitable sensor configured to measure parameters that may be used to determine speed of the flame 140. For example, the first sensor 110 may be an ion sensor, a light sensor, etc. The first sensor 110 may communicate with the controller 150 through a first communication line 112, and may send a signal indicative of the measured at least one parameter associated with the flame 140 to the controller 150 through the first communication line 112. The at least one parameter associated with the flame 140 may include, for example, a time when the flame 140 arrives at the first sensor 110.

In some embodiments, the system 180 may further include a second sensor 110′, which may be similar to the first sensor 110. Second sensor 110′ may be disposed within a predetermined distance from the first sensor 110 within the measurement apparatus 100. Flame 140 may travel from the ignition source 115 to the first sensor 110, and then to the second sensor 110′. Second sensor 110′ may communicate with the controller 150 through a second communication line 112′. Similar to the first sensor 110, the second sensor 110′ may be configured to measure at least one parameter associated with the flame 140, for example, a time flame 140 arrives at the second sensor 110′. Second sensor 110′ may send a signal indicative of the measured parameter to the controller 150 through the second communication line 112′.

The system 180 may further include a flame arrester 125. The flame arrester 125 may be disposed at least partially within the measurement apparatus 100, and may be located between the ignition source 115 and the device 120. The flame arrester 125 may be configured to inhibit propagation of the flame 140 from the ignition source 115 to the device 120, thus protecting the device 120 from heat of the flame 140.

The controller 150 may communicate with the valve 55 that controls the amount of air intake via a communication line 57, and the valve 65 that controls the amount of fuel intake via a communication line 67. For example, the controller 150 may control the valve 55 to adjust the amount of the air supplied to engine 10, and may control the valve 65 to adjust the amount of the fuel supplied to engine 10 so that an air/fuel ratio of the air and fuel may be adjusted.

### INDUSTRIAL APPLICABILITY

Referring to FIG. 1, the amount of air and fuel directed into the measurement apparatus 100 may be adjusted by controlling the device 120 through the controller 150. The air/fuel ratio of the air and fuel supplied to engine 10 may be managed, e.g., maintained without adjustment, or adjusted, if desired, by adjusting the valve 55 that controls the amount of air supply to engine 10, and the valve 65 that controls the amount of fuel supply to engine 10. The controller 150 may be configured to determine a flame speed of the flame 140 propagating within the measurement apparatus 100 based on the at least one measured parameter associated with the flame 140 and measured by the first sensor 110 and/or the second sensor 110′, to control a flame speed in engine 10 by managing the air/fuel ratio of engine 10 based on the determined flame speed, and/or to correlate the determined flame speed with an operating flame speed in engine 10. The at least one measured parameter may include, for example, the time the flame 140 arrives at the first sensor 110 and/or the second sensor 110′.

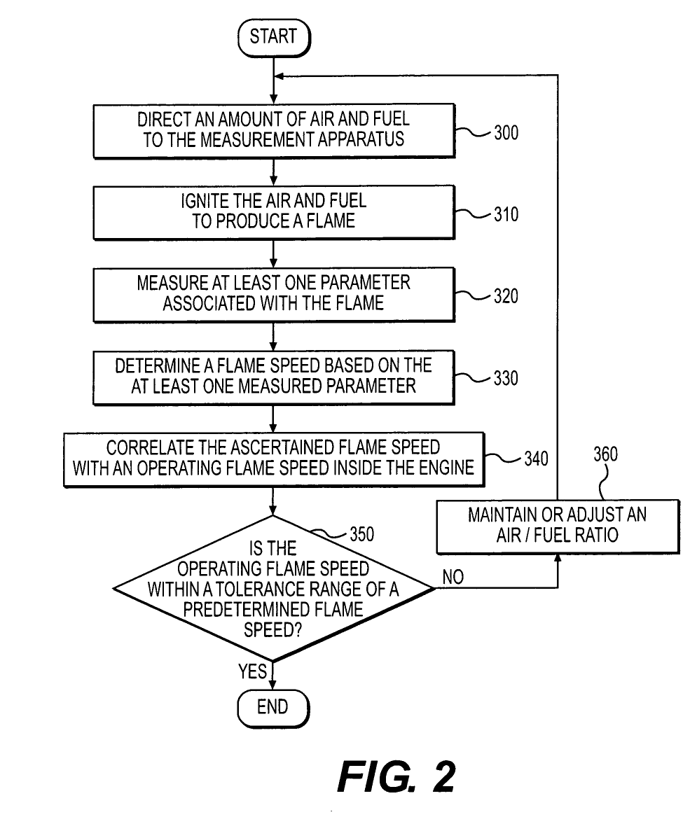

FIG. 2 illustrates an exemplary process of operating the system 180 for controlling engine 10. The process may be carried out regularly, for example, every one hour when engine 10 is operating. The process may start with Step 300, where an amount of air and fuel may be directed to the measurement apparatus 100 by the device 120, which may be controlled by the controller 150. For example, at Step 300, the controller 150 may send a signal to the device 120 via the communication line 122 so that the device 120 is opened to a predetermined extent to allow a predetermined amount of air and fuel to flow into the measurement apparatus 100. After the predetermined amount of air and fuel is directed into the measurement apparatus 100, the controller 150 may send a signal to the device 120 via the communication line 122 to close the device 120 and block the air and fuel flow.

The air and fuel directed into the measurement apparatus 100 may then be ignited by the ignition source 115 to produce the flame 140 propagating within the measurement apparatus, for example, from the ignition source 115 to the first sensor 110 (Step 310). In one embodiment, before igniting the air and fuel, the controller 150 may send a signal to the ignition source 115 via the communication line 117 so that the ignition source 115 is activated to produce, for example, sparks, to ignite the air and fuel. In one embodiment, the ignition source 115 may detect the presence of the air and fuel by itself, or another device (not shown) associated with the ignition source 115 may detect the presence of the air and fuel. The ignition source 115 may then ignite the air and fuel upon detection of the presence of the air and fuel. The time at which the air and fuel is ignited and the flame 140 is produced may be detected by the controller 150. For example, the ignition source 115 may send a signal indicative of the time when the air and fuel is ignited and the flame 140 is produced to the controller 150 via the communication line 117. The controller 150 may receive the signal, and then process the signal for determining the speed of the flame 140.

In some embodiments, the speed of the flame 140 may be determined using the first sensor 110 alone without using the second sensor 110′. For example, when the flame 140 propagating within the measurement apparatus 100 arrives at the first sensor 110, at least one parameter associated with the flame 140 may be measured by the first sensor 110 (Step 320). For example, the at least one parameter may include the time of arrival of the flame 140 at the first sensor 110. The first sensor 110 may generate a signal upon arrival of the flame 140, and may send the signal to the controller 150 via the first communication line 112. The controller 150 may determine the flame speed based on the at least one measured parameter associated with the flame 140 (Step 330). For example, the controller 150 may calculate the flame speed based on the measured time of arrival of the flame 140 at the first sensor 110, the time the air and fuel is ignited and the flame 140 is produced, and the distance between the first sensor 110 and the ignition source 115.

In some embodiments, the speed of the flame 140 may be determined using the first sensor 110 and the second sensor 110′. For example, when the flame 140 propagating within the measurement apparatus 100 arrives at the first sensor 110, at least one parameter, e.g., a first time of arrival of the flame 140 at the first sensor 110, may be measured by the first sensor 110 (Step 320). The first sensor 110 may send a first signal indicative of the first time of arrival to the controller 150. The flame 140 may continue to propagate from the first sensor 110 to the second sensor 110′. The second sensor 110′ may measure a second time of arrival of the flame 140 at the second sensor 110′ (Step 320). The second sensor 110′ may send a second signal indicative of the second time of arrival to the controller 150. Controller 150 may determine the speed of the flame 140 based on the first and second times of arrival and the predetermined distance between the first and second sensors 110 and 110′ (Step 330).

After the flame speed of the flame 140 propagating within the measurement apparatus is determined in Step 330, the controller 150 may further correlate the flame speed of the flame 140 with an operating flame speed in engine 10 (Step 340), for example, through a mapping relationship. The mapping relationship may include a relationship between the measured flame speed of the flame 140 within the measurement apparatus 100, which is external to engine 10, and the operating flame speed in engine 10. The mapping relationship may be realized as a map, a program code, a table, etc. Through such a correlation, the operating flame speed in engine 10 may be accurately determined. Because variations in the environment (e.g., air) and the fuel may directly affect the measured flame speed within the measurement apparatus 100, such effect may also be reflected in the operating flame speed in the engine determined through the correlation. In some embodiments, Step 340 may be omitted. After Step 330, the controller 150 may continue with Step 350.

The controller 150 may determine whether the operating flame speed in engine 10 is or is not within a tolerance range of a predetermined (or desired) operating flame speed of engine 10 (Step 350). If the operating flame speed in engine 10 is within the tolerance range of the predetermined operating flame speed, the current air/fuel ratio of the air and fuel supplied to engine 10 may remain unchanged, and the process may be terminated. Otherwise, the process may be continued with Step 360, where the air/fuel ratio of the air and fuel may be managed, e.g., maintained or adjusted. After managing the air/fuel ratio, the process may return to Step 300 and repeat Steps 300-350. Step 360 may be repeated if indicated by the outcome in Step 350. The process shown in FIG. 2 may be repeated on a regular basis (e.g., once every one hour during engine operation) to ensure the operating flame speed is within the tolerance range of the predetermined operating flame speed.

The disclosed system 180 for controlling a combustion engine 10 may be applicable to any engine system 200 that uses a premixed charge (i.e., air and fuel) and flame-propagation-driven combustion. The disclosed system 180 may be particularly applicable to lean burn combustion engines, and specifically open chamber lean burn combustion engines. As mentioned above, the operating flame speed in engine 10 may fluctuate due to variations in the environment and in the fuel and/or the air. Fluctuating operating flame speed may adversely affect the performance of engine 10, and adversely affect exhaust gas emissions control. By measuring the flame speed external to engine 10 and correlating the measured flame speed external to engine 10 with the operating flame speed in engine 10, the operating flame speed in engine 10 may be accurately determined. Since the flame speed external to engine 10 may be controlled through maintaining or adjusting the air/fuel ratio, the flame speed in engine 10 can be controlled to be substantially constant (i.e., within a tolerance range of a desired operating flame speed), thereby improving the engine performance and emissions control.

It will be apparent to those skilled in the art that various modifications and variations can be made in the disclosed system and method for controlling a combustion engine using flame speed measurement. Other embodiments will be apparent to those skilled in the art from consideration of the specification and practice of the disclosed embodiments herein. It is intended that the specification and examples be considered as exemplary only, with a true scope of the disclosure being indicated by the following claims.

1. A system for controlling a combustion engine, comprising:
a measurement apparatus disposed external to any power producing combustion chamber of the engine;
a device configured to selectively direct an amount of air and fuel to the measurement apparatus;
an ignition source configured to ignite the air and fuel to produce a flame propagating within the measurement apparatus;
a sensor configured to measure at least one parameter associated with the flame propagating within the measurement apparatus and arriving at the sensor; and
a controller configured to:
determine a flame speed within the measurement apparatus based on the at least one measured parameter; and
control an operating flame speed in the engine by managing an air/fuel ratio of the engine based on the determined flame speed.

2. The system of claim 1, wherein the controller is further configured to correlate the determined flame speed with the operating flame speed in the engine.

3. The system of claim 1, wherein a first end of the measurement apparatus is connected with a passage supplying the air and fuel to the engine, and a second end of the measurement apparatus is connected with a portion of an exhaust system associated with the engine.

4. The system of claim 1, further including an exhaust conduit disposed between a portion of the measurement apparatus and a portion of an air intake system.

5. The system of claim 1, wherein the sensor is a first sensor, the system further including a second sensor disposed at a predetermined distance from the first sensor within the measurement apparatus.

6. The system of claim 1, wherein the device includes a valve.

7. The system of claim 1, further including a flame arrester disposed between the device and the ignition source, and configured to inhibit flame propagation from the ignition source to the device.

8. The system of claim 1, wherein the ignition source, the device, and the sensor are disposed within the measurement apparatus.

9. The system of claim 1, wherein the sensor is disposed within the measurement apparatus at a predetermined distance from the ignition source.

10. The system of claim 1, wherein the controller is associated with at least one of the device, the ignition source, and the sensor.

11. A method of controlling a combustion engine, comprising:
directing a selected amount of air and fuel to a measurement apparatus disposed external to any power producing combustion chamber of the engine;
igniting the selected air and fuel to produce a flame propagating within the measurement apparatus;
measuring at least one parameter associated with the flame propagating within the measurement apparatus and arriving at the sensor;
determining a flame speed of the flame within the measurement apparatus based on the at least one measured parameter; and
controlling an operating flame speed in the engine by managing an air/fuel ratio based on the determined flame speed.

12. The method of claim 11, further including correlating the determined flame speed with the operating flame speed in the engine.

13. The method of claim 12, further including determining the operating flame speed from the correlation.

14. The method of claim 12, further including determining whether the operating flame speed is within a tolerance range of a predetermined operating flame speed.

15. The method of claim 12, wherein correlating includes correlating the determined flame speed with the operating flame speed in the engine through a mapping relationship.

16. An engine system, comprising:
a combustion engine including at least one power producing combustion chamber;
an air intake system;
a fuel supply system; and
a system for controlling the combustion engine, including:
a measurement apparatus located external to all of the at least one power producing combustion chamber of the combustion engine;
a device configured to direct a selected amount of air and fuel to the measurement apparatus;
an ignition source configured to ignite the selected air and fuel to produce a flame propagating within the measurement apparatus;
a sensor configured to measure at least one parameter associated with the flame propagating within the measurement apparatus and arriving at the sensor; and
a controller associated with at least one of the device, the ignition source, and the sensor, and configured to:
communicate with the at least one of the device, the ignition source, and the sensor;
determine a flame speed of the flame propagating within the measurement apparatus based on at least the measured parameter; and
control an operating flame speed in the engine by managing an air/fuel ratio of air and fuel supplied to the engine based on the determined flame speed.

17. The engine system of claim 16, wherein the controller is further configured to correlate the determined flame speed of the flame propagating within the measurement apparatus with the operating flame speed in the engine.

18. The engine system of claim 16, wherein the sensor is a first sensor, the engine system further including a second sensor disposed at a predetermined distance from the first sensor within the measurement apparatus.

19. The engine system of claim 16, wherein the ignition source, the device, and the sensor are disposed within the measurement apparatus.

20. The engine system of claim 16, wherein the sensor is disposed within the measurement apparatus at a predetermined distance from the ignition source.

21. The system of claim 1 wherein the sensor is located at a distance from the ignition source.

22. The system of claim 21 wherein the at least one parameter associated with the flame is a time for the flame to arrive at the sensor.

23. The method of claim 11 wherein the measuring at least one parameter associated with the flame is performed at a distance from the igniting.

24. The system of claim 23 wherein the measuring at least one parameter associated with the flame includes measuring a time for the flame to travel the distance.
